(19) United States
(12) Patent Application Publication
(10) Pub. No.: US 2017/0127018 A1
(43) Pub. Date: May 4, 2017

(54) VIDEO INTERACTION METHOD, TERMINAL, SERVER AND SYSTEM

(71) Applicant: GUANGZHOU HUADUO NETWORK TECHNOLOGY CO, LTD., GuangZhou (CN)

(72) Inventors: MU LI, GuangZhou (CN); Ruibin Chen, GuangZhou (CN); Jin Li, GuangZhou (CN)

(21) Appl. No.: 15/309,024

(22) PCT Filed: Dec. 31, 2014
(86) PCT No.: PCT/CN2014/095782

§ 371 Date: Nov. 4, 2016

(30) Foreign Application Priority Data
Feb. 24, 2014 (CN) 201410062381.6

(51) Int. Cl. H04N 7/14; H04L 12/18; H04N 7/15

(52) U.S. Cl. CPC H04N 7/147; H04N 7/155; H04L 12/1822

(57) ABSTRACT

Disclosed are a video interaction method, a terminal, a server, and a system. The method includes: receiving a video microphone-connection invitation transmitted by a first terminal, the video microphone-connection invitation carrying at least one terminal identifier; transmitting the video microphone-connection invitation to a second terminal corresponding to the terminal identifier; after receiving an accept response returned by the second terminal, granting the second terminal a video publishing right, and establishing a microphone-connection session connection between the first terminal and the second terminal; receiving video data published by the first terminal and video data published by the second terminal, wherein the video data published by the first terminal and the video data published by the second terminal are displayed on the same window interface respectively in the first terminal and the second terminal.

This application claims priority to Chinese Patent Application No. 201410062381.6, filed before Chinese Patent Office on Feb. 24, 2014 and entitled “VIDEO INTERACTION METHOD, TERMINAL, SERVER, AND SYSTEM”, the entire contents of which are incorporated herein by reference.

### TECHNICAL FIELD

The present invention relates to the technical field of Internet, and more particularly, to a video interaction method, a terminal, a server, and a system.

### BACKGROUND

With popularization of the Internet, Internet applications of the streaming media type have been widely developed. Video streaming media, being a critical part in streaming media, attract an increasing number of users due to novel forms and rich content. To improve the user experience, it is concerned by persons skilled in the art on how to perform more diversified video interaction.

During video interaction in the related art, no matter for an anchor (video publisher) or audience (video receiver), a single-user video is generally displayed on a window interface. To perform multi-user video communication, multiple video areas need to be opened, a single-user video is displayed in each video area, and the multiple video areas are located on multiple window interfaces.

The interaction modes are limited because interaction is only performed in a single-user video mode or a multi-user video mode in multiple specified video areas.

### SUMMARY

To solve the problem in the related art, an embodiment of the present invention provides a video interaction method, a terminal, a server, and a system. The technical solutions are as follows.

In a first aspect, a video interaction method is provided, which includes:

receiving a video microphone-connection invitation transmitted by a first terminal, the video microphone-connection invitation carrying at least one terminal identifier;

transmitting the video microphone-connection invitation to a second terminal corresponding to the terminal identifier;

after receiving an accept response returned by the second terminal, granting the second terminal a video publishing right, and establishing a microphone-connection session connection between the first terminal and the second terminal;

receiving video data published by the first terminal and video data published by the second terminal; and

transmitting the video data published by the first terminal to the second terminal, transmitting the video data published by the second terminal to the first terminal, such that the first terminal displays the video data published by the first terminal and the video data published by the second terminal on the same window interface, and the second terminal displays the video data published by the first terminal and the video data published by the second terminal on the same window interface.

With reference to the first aspect, in a first possible implementation manner of the first aspect, after establishing a microphone-connection session connection between the first terminal and the second terminal, the method further includes:

receiving a microphone-connection cancel notification transmitted by the first terminal; and

disconnecting the microphone-connection session connection between the first terminal and the second terminal according to the microphone-connection cancel notification, and transmitting a microphone-connection stop notification to the second terminal, to stop the second terminal from publishing a video.

With reference to the first aspect, in a second possible implementation manner of the first aspect, after establishing a microphone-connection session connection between the first terminal and the second terminal, the method further includes:

receiving a video publishing stop notification transmitted by the second terminal; and

disconnecting the microphone-connection session connection between the first terminal and the second terminal according to the video publishing stop notification, and transmitting a microphone-connection stop notification to the first terminal, to stop the first terminal from displaying the video data published by the second terminal on the window interface.

With reference to the first aspect or the first and second possible implementation manners of the first aspect, in a third possible implementation manner of the first aspect, after receiving video data published by the first terminal and video data published by the second terminal, the method further includes:

transmitting a subscription notification to at least one third terminal, and receiving a subscription request returned by the third terminal, the subscription notification being used for notifying subscription to the video data published by the first terminal and the video data published by the second terminal; and

transmitting, according to the subscription request, the video data published by the first terminal and the video data published by the second terminal to the third terminal, such that the third terminal displays the video data published by the first terminal and the video data published by the second terminal on the same window interface.

With reference to the third possible implementation manner of the first aspect, in a fourth possible implementation manner of the first aspect, after disconnecting the microphone-connection session connection between the first terminal and the second terminal, the method further includes:

transmitting a subscription stop notification to the third terminal, to stop the third terminal from displaying the video data published by the second terminal.

With reference to the first aspect, in a fifth possible implementation manner of the first aspect, before transmitting the video microphone-connection invitation to a second terminal corresponding to the terminal identifier, the method further includes:

checking whether the second terminal has a video publishing right; and

transmitting the video microphone-connection invitation to the second terminal when the second terminal has the video publishing right.

In a second aspect, a video interaction method is provided, which includes:

transmitting a video microphone-connection invitation to a server, the video microphone-connection invitation carrying at least one terminal identifier, such that the server transmits the video microphone-connection invitation to a second terminal corresponding to the terminal identifier, and establishes a microphone-connection session connection with the second terminal after receiving an accept response returned by the second terminal;

acquiring local video data, and uploading the acquired local video data to the server; and

acquiring video data published by the second terminal, and displaying the acquired local video data and the video data published by the second terminal on the same window interface.

In a third aspect, a video interaction method is provided, which includes:

receiving a video microphone-connection invitation transmitted by a server, the video microphone-connection invitation being transmitted by a first terminal to the server;

returning an accept response to the server, and acquiring local video data after being granted a video publishing right; and

uploading the acquired local video data to the server, acquiring video data published by the first terminal, and displaying the acquired local video data and the video data published by the first terminal on the same window interface.

In a fourth aspect, a video interaction method is provided, which includes:

receiving a subscription notification transmitted by a server, and returning a subscription request to the server, the subscription notification being used for notifying subscription to video data published by a first terminal and video data published by a second terminal; and

receiving the video data transmitted by the server according to the subscription request, the video data being the video data published by the first terminal and the video data published by the second terminal, and displaying the video data published by the first terminal and the video data published by the second terminal on the same window interface.

With reference to the fourth aspect, in a first possible implementation manner of the fourth aspect, after returning a subscription request to the server, the method further includes:

receiving a subscription stop notification transmitted by the server, and stopping displaying the video data published by the second terminal according to the subscription stop notification.

In a fifth aspect, a server is provided, which includes:

a first receiving module, configured to receive a video microphone-connection invitation transmitted by a first terminal, the video microphone-connection invitation carrying at least one terminal identifier;

a first transmitting module, configured to transmit the video microphone-connection invitation to a second terminal corresponding to the terminal identifier;

a right granting module, configured to grant the second terminal a video publishing right after receiving an accept response returned by the second terminal;

an establishing module, configured to establish a microphone-connection session connection between the first terminal and the second terminal; and

a second receiving module, configured to receive video data published by the first terminal and video data published by the second terminal, transmit the video data published by the first terminal to the second terminal, transmit the video data published by the second terminal to the first terminal, wherein the first terminal displays the video data published by the first terminal and the video data published by the second terminal on the same window interface, and the second terminal displays the video data published by the first terminal and the video data published by the second terminal on the same window interface.

With reference to the fifth aspect, in a first possible implementation manner of the fifth aspect, the server further includes:

a third receiving module, configured to receive a microphone-connection cancel notification transmitted by the first terminal;

a first disconnecting module, configured to disconnect the microphone-connection session connection between the first terminal and the second terminal according to the microphone-connection cancel notification; and

a second transmitting module, configured to transmit a microphone-connection stop notification to the second terminal, to stop the second terminal from publishing a video.

With reference to the fifth aspect, in a second possible implementation manner of the fifth aspect, the server further includes:

a fourth receiving module, configured to receive a video publishing stop notification transmitted by the second terminal;

a second disconnecting module, configured to disconnect the microphone-connection session connection between the first terminal and the second terminal according to the video publishing stop notification; and

a third transmitting module, configured to transmit a microphone-connection stop notification to the first terminal, to stop the first terminal from displaying the video data published by the second terminal on the window interface.

With reference to the fifth aspect or the first and second possible implementation manners of the fifth aspect, in a third possible implementation manner of the fifth aspect, the server further includes:

a fourth transmitting module, configured to transmit a subscription notification to at least one third terminal, the subscription notification being used for notifying subscription to the video data published by the first terminal and the video data published by the second terminal;

a fifth receiving module, configured to receive a subscription request returned by the third terminal; and

a fifth transmitting module, configured to transmit, according to the subscription request, the video data published by the first terminal and the video data published by the second terminal to the third terminal, such that the third terminal displays the video data published by the first terminal and the video data published by the second terminal on the same window interface.

With reference to the third possible implementation manner of the fifth aspect, in a fourth possible implementation manner of the fifth aspect, the server further includes:

a sixth transmitting module, configured to transmit a subscription stop notification to the third terminal, to stop the third terminal from displaying the video data published by the second terminal.

With reference to the fifth aspect, in a fifth possible implementation manner of the fifth aspect, the server further includes:

a right checking module, configured to check whether the second terminal has a video publishing right; and

the first transmitting module, configured to, transmit the video microphone-connection invitation to the second terminal when the second terminal has the video publishing right.

In a sixth aspect, a terminal is provided, which includes:

a first transmitting module, configured to transmit a video microphone-connection invitation to a server, the video microphone-connection invitation carrying at least one terminal identifier, such that the server transmits the video microphone-connection invitation to a second terminal corresponding to the terminal identifier, and establishes a microphone-connection session connection with the second terminal after receiving an accept response returned by the second terminal;

a first acquiring module, configured to acquire local video data;

a second acquiring module, configured to acquire video data published by the second terminal; and

a display module, configured to display the acquired local video data and the video data published by the second terminal on the same window interface.

In a seventh aspect, a terminal is provided, which includes:

a receiving module, configured to receive a video microphone-connection invitation transmitted by a server, the video microphone-connection invitation being transmitted by a first terminal to the server;

a returning module, configured to return an accept response to the server;

a first acquiring module, configured to acquire local video data after being granted a video publishing right;

a second acquiring module, configured to acquire video data published by the first terminal; and

a display module, configured to display the acquired local video data and the video data published by the first terminal on the same window interface.

In an eighth aspect, a terminal is provided, which includes:

a first receiving module, configured to receive a subscription notification transmitted by a server, the subscription notification being used for notifying subscription to video data published by a first terminal and video data published by a second terminal;

a returning module, configured to return a subscription request to the server;

a second receiving module, configured to receive the video data transmitted by the server according to the subscription request, the video data being the video data published by the first terminal and the video data published by the second terminal; and

a display module, configured to display the video data published by the first terminal and the video data published by the second terminal on the same window interface.

With reference to the eighth aspect, in a first possible implementation manner of the eighth aspect, the terminal further includes:

a third receiving module, configured to receive a subscription stop notification transmitted by the server; and

a stopping module, configured to stop displaying the video data published by the second terminal according to the subscription stop notification.

In a ninth aspect, a system is provided, which includes: a server, a first terminal, and a second terminal;

the server being as the server in the fifth aspect;

the first terminal being as the first terminal in the sixth aspect; and

the second terminal being as the second terminal in the seventh aspect.

With reference to the ninth aspect, in a first possible implementation manner of the ninth aspect, the system further includes: a third terminal, the third terminal being as the third terminal in the eighth aspect.

In a tenth aspect, a server is provided, which includes: a central processing unit (CPU), a network interface unit, and a system memory. The system memory stores a set of program code, and the CPU is configured to invoke, through a system bus, the program code stored in the system memory, to perform the following operations:

receiving a video microphone-connection invitation transmitted by a first terminal, the video microphone-connection invitation carrying at least one terminal identifier; transmitting the video microphone-connection invitation to a second terminal corresponding to the terminal identifier; after receiving an accept response returned by the second terminal, granting the second terminal a video publishing right, and establishing a microphone-connection session connection between the first terminal and the second terminal; receiving video data published by the first terminal and video data published by the second terminal; and transmitting the video data published by the first terminal to the second terminal, transmitting the video data published by the second terminal to the first terminal, wherein the first terminal displays the video data published by the first terminal and the video data published by the second terminal on the same window interface, and the second terminal displays the video data published by the first terminal and the video data published by the second terminal on the same window interface.

With reference to the tenth aspect, in a first possible implementation manner of the tenth aspect, the CPU is configured to invoke the program code stored in the system memory, to perform the following operations:

receiving a microphone-connection cancel notification transmitted by the first terminal; and disconnecting the microphone-connection session connection between the first terminal and the second terminal according to the microphone-connection cancel notification, and transmitting a microphone-connection stop notification to the second terminal, to stop the second terminal from publishing a video.

With reference to the tenth aspect, in a second possible implementation manner of the tenth aspect, the CPU is configured to invoke the program code stored in the system memory, to perform the following operations:

receiving a video publishing stop notification transmitted by the second terminal; and disconnecting the microphone-connection session connection between the first terminal and the second terminal according to the video publishing stop notification, and transmitting a microphone-connection stop notification to the first terminal, to stop the first terminal from displaying the video data published by the second terminal on the window interface.

With reference to the tenth aspect or the first and second possible implementation manners of the tenth aspect, in a third possible implementation manner of the tenth aspect, the CPU is configured to invoke the program code stored in the system memory, to perform the following operations:

transmitting a subscription notification to at least one third terminal, and receiving a subscription request returned by the third terminal, the subscription notification being used for notifying subscription to the video data published by the first terminal and the video data published by the second terminal; and transmitting, according to the subscription request, the video data published by the first terminal and the video data published by the second terminal to the third terminal, such that the third terminal displays the video data published by the first terminal and the video data published by the second terminal on the same window interface.

With reference to the third possible implementation manner of the tenth aspect, in a fourth possible implementation manner of the tenth aspect, the CPU is configured to invoke the program code stored in the system memory, to perform the following operation:

transmitting a subscription stop notification to the third terminal, to stop the third terminal from displaying the video data published by the second terminal.

With reference to the tenth aspect, in a fifth possible implementation manner of the tenth aspect, the CPU is configured to invoke the program code stored in the system memory, to perform the following operations:

checking whether the second terminal has a video publishing right; and transmitting the video microphone-connection invitation to the second terminal when the second terminal has the video publishing right.

In an eleventh aspect, a terminal is provided, which includes: a CPU, a network interface unit, a sensor, a microphone, a display, and a system memory. The system memory stores a set of program code, and the CPU is configured to invoke, through a system bus, the program code stored in the system memory, to perform the following operations:

transmitting a video microphone-connection invitation to a server, the video microphone-connection invitation carrying at least one terminal identifier, such that the server transmits the video microphone-connection invitation to a second terminal corresponding to the terminal identifier, and establishes a microphone-connection session connection with the second terminal after receiving an accept response returned by the second terminal; acquiring local video data, and uploading the acquired local video data to the server; and acquiring video data published by the second terminal, and displaying the acquired local video data and the video data published by the second terminal on the same window interface.

In a twelfth aspect, a terminal is provided, which includes: a CPU, a network interface unit, a sensor, a microphone, a display, and a system memory. The system memory stores a set of program code, and the CPU is configured to invoke, through a system bus, the program code stored in the system memory, to perform the following operations:

receiving a video microphone-connection invitation transmitted by a server, the video microphone-connection invitation being transmitted by a first terminal to the server; returning an accept response to the server, and acquiring local video data after being granted a video publishing right; and uploading the acquired local video data to the server, acquiring video data published by the first terminal, and displaying the acquired local video data and the video data published by the first terminal on the same window interface.

In a thirteenth aspect, a terminal is provided, which includes: a CPU, a network interface unit, a sensor, a microphone, a display, and a system memory. The system memory stores a set of program code, and the CPU is configured to invoke, through a system bus, the program code stored in the system memory, to perform the following operations:

receiving a subscription notification transmitted by a server, and returning a subscription request to the server, the subscription notification being used for notifying subscription to video data published by a first terminal and video data published by a second terminal; receiving the video data transmitted by the server according to the subscription request, the video data being the video data published by the first terminal and the video data published by the second terminal, and displaying the video data published by the first terminal and the video data published by the second terminal on the same window interface.

With reference to the thirteenth aspect, in a first possible implementation manner of the thirteenth aspect, the CPU is configured to invoke the program code stored in the system memory, to perform the following operations:

receiving a subscription stop notification transmitted by the server, and stopping displaying the video data published by the second terminal according to the subscription stop notification.

The technical solutions provided by the embodiments of the present invention have the following beneficial effects:

By transmitting a video microphone-connection invitation, carrying at least one terminal identifier and transmitted by a first terminal, to a second terminal corresponding to the terminal identifier; after receiving an accept response returned by the second terminal, granting the second terminal a video publishing right, and establishing a microphone-connection session connection between the first terminal and the second terminal; displaying video data published by the first terminal and video data published by the second terminal on the same window interface in the first terminal, and displaying the video data published by the first terminal and the video data published by the second terminal on the same window interface in the second terminal, the video interaction mode is enriched.

### BRIEF DESCRIPTION OF THE DRAWINGS

To illustrate the technical solutions in the embodiments of the present invention more clearly, the accompanying drawings required for describing the embodiments are introduced briefly in the following. Apparently, the accompanying drawings in the following description are only some embodiments of the present invention, and persons of ordinary skill in the art can derive other drawings from the accompanying drawings without creative efforts.

FIG. 1 is a flowchart of a first video interaction method according to Embodiment 1 of the present invention;

FIG. 2 is a flowchart of a second video interaction method according to Embodiment 1 of the present invention;

FIG. 3 is a flowchart of a third video interaction method according to Embodiment 1 of the present invention;

FIG. 4 is a flowchart of a fourth video interaction method according to Embodiment 1 of the present invention;

FIG. 5 is a flowchart of a video interaction method according to Embodiment 2 of the present invention;

FIG. 6 is a schematic diagram illustrating a window of a first terminal according to Embodiment 2 of the present invention;

FIG. 7 is a schematic diagram illustrating a window of a first terminal according to Embodiment 3 of the present invention;

FIG. 8 is a schematic structural diagram of a server according to Embodiment 3 of the present invention;

FIG. 9 is a schematic structural diagram of a terminal according to Embodiment 4 of the present invention;

FIG. 10 is a schematic structural diagram of a terminal according to Embodiment 5 of the present invention;

FIG. 11 is a schematic structural diagram of a terminal according to Embodiment 6 of the present invention;

FIG. 12 is a schematic structural diagram of a video interaction system according to Embodiment 7 of the present invention;

FIG. 13 shows an illustrative terminal system structure of a terminal 1300 used in Embodiment 8 of the present invention;

FIG. 14 is a schematic structural diagram of a terminal mentioned in Embodiment 9 of the present invention; and

FIG. 15 is a schematic structural diagram of a server mentioned in Embodiment 10 of the present invention.

### DETAILED DESCRIPTION

To make the objectives, technical solutions and advantages of the present invention clearer, the embodiments of the present invention are further described in detail below with reference to the accompanying drawings.

### Embodiment 1

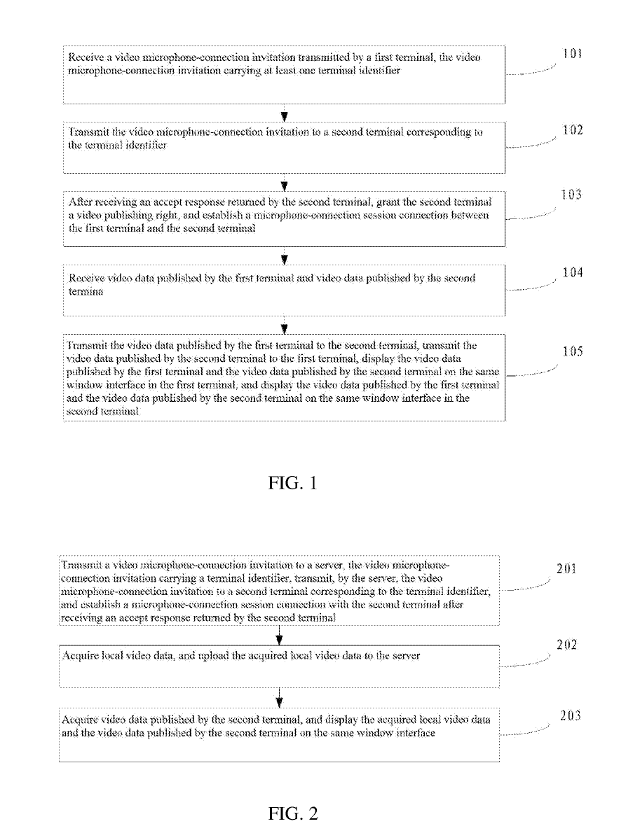

An embodiment of the present invention provides a video interaction method, and from the aspect that the method is performed on a server side, referring to FIG. 1, the process of the method provided by this embodiment includes:

101: Receive a video microphone-connection invitation transmitted by a first terminal, the video microphone-connection invitation carrying at least one terminal identifier.

102: Transmit the video microphone-connection invitation to a second terminal corresponding to the terminal identifier.

103: After receiving an accept response returned by the second terminal, grant the second terminal a video publishing right, and establish a microphone-connection session connection between the first terminal and the second terminal.

104: Receive video data published by the first terminal and video data published by the second terminal.

105: Transmit the video data published by the first terminal to the second terminal, transmit the video data published by the second terminal to the first terminal, display the video data published by the first terminal and the video data published by the second terminal on the same window interface in the first terminal, and display the video data published by the first terminal and the video data published by the second terminal on the same window interface in the second terminal.

In a preferred embodiment, after establishing a microphone-connection session connection between the first terminal and the second terminal, the method further includes:

receiving a microphone-connection cancel notification transmitted by the first terminal; and

disconnecting the microphone-connection session connection between the first terminal and the second terminal according to the microphone-connection cancel notification, and transmitting a microphone-connection stop notification to the second terminal, to stop the second terminal from publishing a video.

In a preferred embodiment, after establishing a microphone-connection session connection between the first terminal and the second terminal, the method further includes:

receiving a video publishing stop notification transmitted by the second terminal; and

disconnecting the microphone-connection session connection between the first terminal and the second terminal according to the video publishing stop notification, and transmitting a microphone-connection stop notification to the first terminal, to stop displaying the video data published by the second terminal on the window interface in the first terminal.

In a preferred embodiment, after receiving video data published by the first terminal and video data published by the second terminal, the method further includes:

transmitting a subscription notification to at least one third terminal, and receiving a subscription request returned by the third terminal, the subscription notification being used for notifying subscription to the video data published by the first terminal and the video data published by the second terminal; and

transmitting, according to the subscription request, the video data published by the first terminal and the video data published by the second terminal to the third terminal, and displaying the video data published by the first terminal and the video data published by the second terminal on the same window interface in the third terminal.

In a preferred embodiment, after disconnecting the microphone-connection session connection between the first terminal and the second terminal, the method further includes:

transmitting a subscription stop notification to the third terminal, to stop displaying the video data published by the second terminal in the third terminal.

In a preferred embodiment, before transmitting the video microphone-connection invitation to a second terminal corresponding to the terminal identifier, the method further includes:

checking whether the second terminal has a video publishing right; and

if the second terminal has the video publishing right, transmitting the video microphone-connection invitation to the second terminal.

From the aspect that the method is performed on a first terminal side, referring to FIG. 2, the process of the method provided by this embodiment includes:

201: Transmit a video microphone-connection invitation to a server, the video microphone-connection invitation carrying at least one terminal identifier, transmit, by the server, the video microphone-connection invitation to a second terminal corresponding to the terminal identifier, and establish a microphone-connection session connection with the second terminal after receiving an accept response returned by the second terminal.

202: Acquire local video data, and upload the acquired local video data to the server.

203: Acquire video data published by the second terminal, and display the acquired local video data and the video data published by the second terminal on the same window interface.

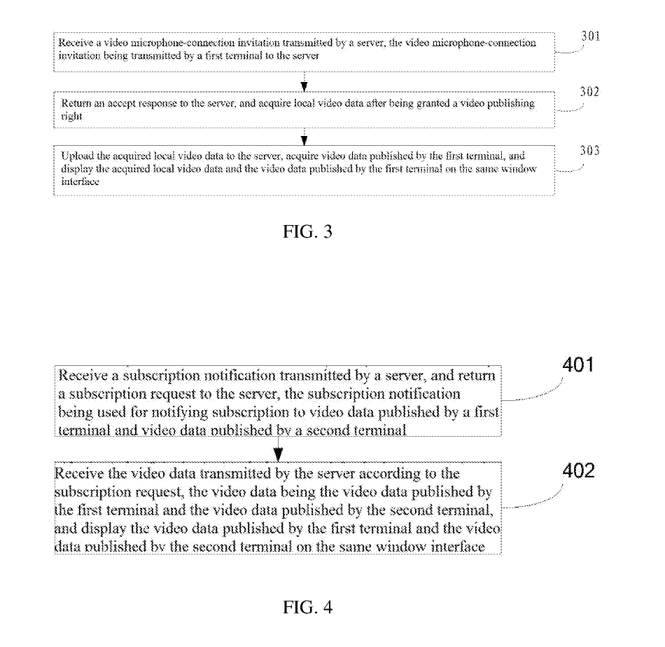

From the aspect that the method is performed on a second terminal side, referring to FIG. 3, the process of the method provided by this embodiment includes:

301: Receive a video microphone-connection invitation transmitted by a server, the video microphone-connection invitation being transmitted by a first terminal to the server.

302: Return an accept response to the server, and acquire local video data after being granted a video publishing right.

303: Upload the acquired local video data to the server, acquire video data published by the first terminal, and display the acquired local video data and the video data published by the first terminal on the same window interface.

From the aspect that the method is performed on a third terminal side, referring to FIG. 4, the process of the method provided by this embodiment includes:

401: Receive a subscription notification transmitted by a server, and return a subscription request to the server, the subscription notification being used for notifying subscription to video data published by a first terminal and video data published by a second terminal.

402: Receive the video data transmitted by the server according to the subscription request, the video data being the video data published by the first terminal and the video data published by the second terminal, and display the video data published by the first terminal and the video data published by the second terminal on the same window interface.

In a preferred embodiment, after returning a subscription request to the server, the method further includes:

receiving a subscription stop notification transmitted by the server, and stopping displaying the video data published by the second terminal according to the subscription stop notification.

In the method provided by this embodiment, by transmitting a video microphone-connection invitation, carrying at least one terminal identifier and transmitted by a first terminal, to a second terminal corresponding to the terminal identifier; after receiving an accept response returned by the second terminal, granting the second terminal a video publishing right, and establishing a microphone-connection session connection between the first terminal and the second terminal; displaying video data published by the first terminal and video data published by the second terminal on the same window interface in the first terminal, and displaying the video data published by the first terminal and the video data published by the second terminal on the same window interface in the second terminal, the video interaction mode is enriched.

### Embodiment 2

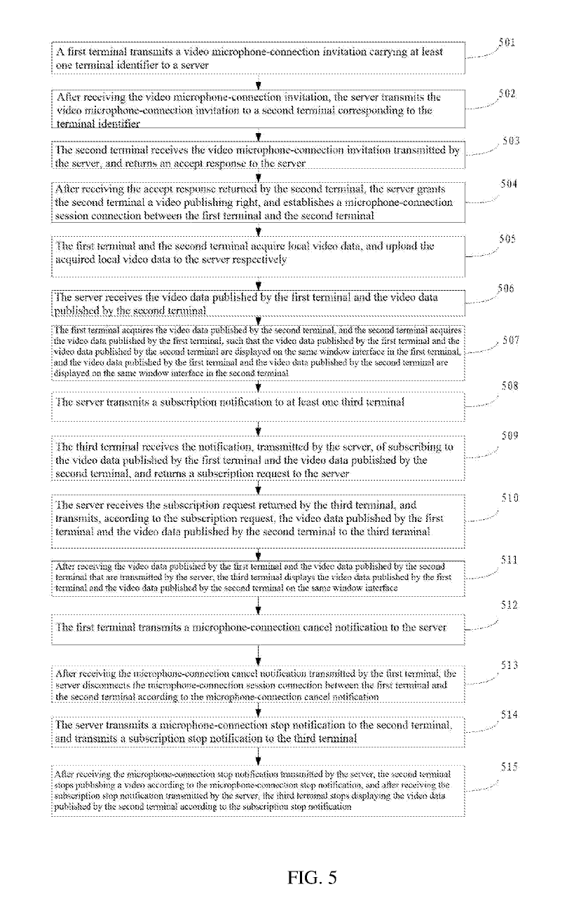

With popularization of the Internet, the number of users for video streaming media client grows. Because conventional single-user video or multi-user video in specified areas cannot meet the requirements of users, more diversified video interaction modes are provided, which is critical to the development of streaming media technologies. Therefore, an embodiment of the present invention provides a video interaction method, and for ease of understanding, with reference to the content of Embodiment 1, the video interaction method provided by the embodiment of the present invention is illustrated in detail. Referring to FIG. 5, the process of the method provided by this embodiment includes:

501: A first terminal transmits a video microphone-connection invitation carrying at least one terminal identifier to a server.

The first terminal is a terminal capable of transmitting a video microphone-connection invitation, that is, a terminal used by an anchor. The first terminal may be a video session-supported terminal such as a computer or smartphone, and the first terminal is not specifically limited in this embodiment. The video microphone-connection invitation carries at least one terminal identifier. The terminal identifier may be a device type of the terminal, information of a CPU, a media access control (MAC) address, device unique information and the like, and the terminal identifier is not specifically limited in this embodiment.

Specifically, a video microphone-connection session is a multi-user video session established by the first terminal as an initiator with a second terminal through the server. The video interaction content may be enriched through the video microphone-connection session. The second terminal is a terminal incapable of transmitting a video microphone-connection invitation, and may be a video session-supported terminal such as a computer or smartphone. The second terminal is also not specifically limited in this embodiment.

502: After receiving the video microphone-connection invitation, the server transmits the video microphone-connection invitation to a second terminal corresponding to the terminal identifier.

After receiving the video microphone-connection invitation transmitted by the first terminal, the server may determine a second terminal according to the at least one terminal identifier carried in the video microphone-connection invitation, and transmit the video microphone-connection invitation to the second terminal corresponding to the terminal identifier.

Preferably, for network security, to prevent persons of malicious intention from publishing improper videos on the Internet, after receiving the video microphone-connection invitation transmitted by the first terminal, the server also checks whether the second terminal has a video publishing right. If the second terminal does not have the video publishing right, the server does not perform the operation of transmitting the video microphone-connection invitation to the second terminal; and if the second terminal has the video publishing right, the server transmits the video microphone-connection invitation to the second terminal. The manner in which the server checks whether the second terminal has a video publishing right is not specifically limited in this embodiment. In the specific implementation, the server may maintain a list of identifiers of terminals having no video publishing right. Before transmitting the video microphone-connection invitation to the second terminal, the server queries whether the terminal identifier list contains the terminal identifier carried in the video microphone-connection invitation; if the terminal identifier list contains the terminal identifier carried in the video microphone-connection invitation, it is determined that the second terminal does not have the video publishing right, and if the terminal identifier list does not contain the terminal identifier carried in the video microphone-connection invitation, it is determined that the second terminal has the video publishing right.

503: The second terminal receives the video microphone-connection invitation transmitted by the server, and returns an accept response to the server.

To improve the video experience effect of a user, the second terminal returns an accept response to the server after receiving the video microphone-connection invitation transmitted by the server. Therefore, in the subsequent step, the server establishes a microphone-connection session connection between the first terminal and the second terminal after receiving the accept response transmitted by the second terminal.

Preferably, to enable a user on the second terminal side to freely decide whether to have a microphone-connection session with a user on the first terminal side, the method provided by this embodiment may also provide a response reply option. The user on the second terminal side may decide whether to have a microphone-connection session with the user on the first terminal side through the response reply option after the second terminal receives the video microphone-connection invitation transmitted by the server. The reply option includes, but is not limited to, “accept” or “deny”. Specifically, if the user of the second terminal side intends to have a microphone-connection session with the user of the first terminal side, the user of the second terminal side may select the “accept” option through an operation such as mouse click; and if the user of the second terminal side does not want to have a microphone-connection session with the user of the first terminal side, the user of the second terminal side may select the “deny” option through an operation such as mouse click. The second terminal determines whether to return an accept response to the server through detecting an operation of which option is selected. The second terminal determines to return an accept response to the server after detecting that the “accept” option is selected.

504: After receiving the accept response returned by the second terminal, the server grants the second terminal a video publishing right, and establishes a microphone-connection session connection between the first terminal and the second terminal.

Since the second terminal returns the accept response to the server, it indicates that the user of the second terminal side intends to have a microphone-connection session with the user of the first terminal side. Therefore, after receiving the accept response returned by the second terminal, the server may establish a microphone-connection session connection between the first terminal and the second terminal. The user on the first terminal side and the user on the second terminal side can have a microphone-connection session through the microphone-connection session connection established by the server.

Further, as only the first terminal has the video publishing right and the second terminal does not have the video publishing right in a single-user video mode, the video interaction experience of users is poor. To improve the video interaction experience of users, in the embodiment of the present invention, the server also grants the second terminal the video publishing right when establishing the microphone-connection session connection between the first terminal and the second terminal, such that the second terminal can publish a video when having a microphone-connection session with the first terminal. Therefore, a new interaction mode is provided, to improve the video interaction experience of users.

505: The first terminal and the second terminal acquire local video data, and upload the acquired local video data to the server respectively.

To enable the user on the first terminal side and the user on the second terminal side to perform video interaction, after the microphone-connection session connection is established between the first terminal and the second terminal, the first terminal and the second terminal acquire local video data, and upload the acquired local video data to the server respectively.

The manner in which the first terminal and the second terminal acquire the local video data includes, but is not limited to, acquiring image information through a built-in camera, acquiring sound data through a microphone, and integrating the acquired image data and sound data to obtain local video data. The manner in which the first terminal and the second terminal upload the acquired local video data to the server includes, but is not limited to, packaging the acquired local video data, and uploading the packaged data to the server over a network.

506: The server receives the video data published by the first terminal and the video data published by the second terminal.

The video data published by the first terminal and the video data published by the second terminal are important information for video interaction. To enable terminals other than the first terminal and the second terminal to acquire the video data published by the first terminal and the video data published by the second terminal, the method provided by this embodiment includes a step in which the first terminal and the second terminal upload the published video data to the server, and the server receives the video data published by the first terminal and the video data published by the second terminal.

Preferably, to facilitate the use of the video data published by the first terminal and the video data published by the second terminal in the subsequent information interaction process, the server stores the received video data after receiving the video data published by the first terminal and the video data published by the second terminal. The manner in which the server stores the video data published by the first terminal and the video data published by the second terminal includes, but is not limited to, storing the received video data published by the first terminal and the received video data published by the second terminal into a corresponding storage medium. The storage medium may be a memory, a flash memory, or a hard disk, which is not specifically limited in the embodiment of the present invention.

507: The first terminal acquires the video data published by the second terminal, and the second terminal acquires the video data published by the first terminal, such that the video data published by the first terminal and the video data published by the second terminal are displayed on the same window interface in the first terminal, and the video data published by the first terminal and the video data published by the second terminal are displayed on the same window interface in the second terminal.

To enable the user of the first terminal side to have the multi-user video interaction experience on the first terminal and enable the user of the second terminal side to have the multi-user video interaction experience on the second terminal, after the first terminal and the second terminal upload the local video data to the server respectively, the first terminal acquires the video data published by the second terminal, and the second terminal acquires the video data published by the first terminal.

Since the first terminal and the second terminal have uploaded the local video data to the server respectively, the first terminal may acquire the video data published by the second terminal and the second terminal may acquire the video data published by the first terminal through the server respectively. Specifically, the server may transmit the video data published by the first terminal to the second terminal, such that not only the video data for the user of the second terminal side but also the video data for the user of the first terminal side may be displayed in the second terminal. Definitely, the server may also transmit the video data published by the second terminal to the first terminal, such that not only the video data for the user of the first terminal side but also the video data for the user of the second terminal side may be displayed in the first terminal. That is, the video data published by the first terminal and the video data published by the second terminal are displayed on the same window interface in the first terminal, and the video data published by the first terminal and the video data published by the second terminal are displayed on the same window interface in the second terminal.

For ease of understanding of the above process, detailed description is provided below with an example that the video data published by the first terminal is flower and the video data published by the second terminal is grass.

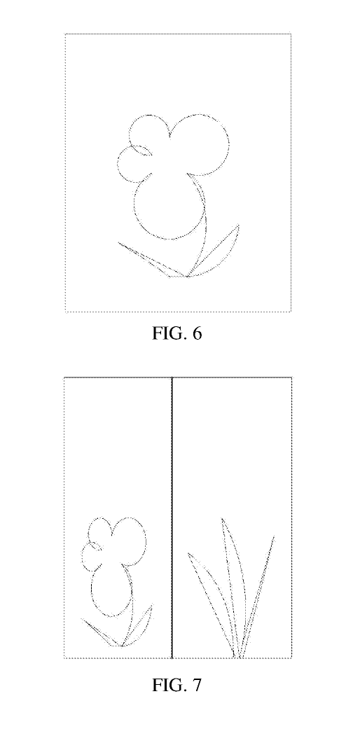

FIG. 6 shows a window interface in the first terminal, and the video data displayed on the window interface is “flower”. To improve the video interaction experience, the first terminal transmits a video microphone-connection invitation carrying a terminal identifier to the server. After receiving the video microphone-connection invitation, the server transmits the video microphone-connection invitation to the second terminal corresponding to the terminal identifier. After receiving an accept response returned by the second terminal, the server establishes a microphone-connection session connection between the first terminal and the second terminal.

To enable the user on the first terminal side and the user on the second terminal side to perform video interaction, the first terminal and the second terminal further acquire local video data, and upload the acquired local video data to the server respectively. After receiving the video data published by the first terminal and the video data published by the second terminal, the server transmits the video data “grass” published by the second terminal to the first terminal. At this time, not only the video data “flower” published by the first terminal but also the video data “grass” published by the second terminal may be displayed on the window interface in the first terminal, which is specifically shown in FIG. 7. Definitely, the server may also transmit the video data “flower” published by the first terminal to the second terminal, such that not only the video data “grass” published by the second terminal but also the video data “flower” published by the first terminal may be displayed on the window interface in the second terminal.

Definitely, in addition to the above manner, the first terminal and the second terminal may also directly acquire video data through the microphone-connection session connection established there-between by the server. Specifically, the first terminal may directly acquire the video data published by the second terminal through the microphone-connection session connection, and meanwhile the second terminal may also directly acquire the video data published by the first terminal through the microphone-connection session connection. Therefore, the video data published by the first terminal and the video data published by the second terminal may be displayed on the same window interface respectively in the first terminal and the second terminal.

508: The server transmits a subscription notification to at least one third terminal.

The third terminal is a video playback-supported terminal such as a computer or smartphone, which is not specifically limited in this embodiment. To further improve the video interaction experience and enable a user on the third terminal side that does not receive a microphone-connection session invitation from the first terminal to view the video data published by the first terminal and the video data published by the second terminal, the server also transmits a subscription notification to at least one third terminal, the subscription notification being used for notifying the at least one third terminal to subscribe to the video data published by the first terminal and the video data published by the second terminal.

The manner in which the server transmits a subscription notification to at least one third terminal includes, but is not limited to, transmitting a subscription notification to at least one third terminal through a mail, network ad, or the like, which is not specifically limited in the embodiment of the present invention. The content of the subscription notification transmitted by the server to the at least one third terminal includes, but is not limited to, video introduction, publishing time, and video length, which is also not specifically limited in this embodiment.

509: The third terminal receives the notification, transmitted by the server, of subscribing to the video data published by the first terminal and the video data published by the second terminal, and returns a subscription request to the server.

After receiving the notification, transmitted by the server, of subscribing to the video data published by the first terminal and the video data published by the second terminal, the third terminal presents the received notification to the user on the third terminal side, and provides a subscription option to the user. The subscription option provided by the third terminal includes, but is not limited to, “subscribe to the video data published by the first terminal and the video data published by the second terminal”, “subscribe to the video data published by the first terminal” and the like. If the user on the third terminal side selects the option “subscribe to the video data published by the first terminal and the video data published by the second terminal” through an operation such as mouse click, after detecting that the option “subscribe to the video data published by the first terminal and the video data published by the second terminal” is selected, the third terminal returns, to the server, a subscription request of subscribing to the video data published by the first terminal and the video data published by the second terminal.

Definitely, in addition to subscribing to the video data published by the first terminal and the video data published by the second terminal, the third terminal may also subscribe to the video data published by the first terminal or the video data published by the second terminal, or may not subscribe to any video data, which is not specifically limited in the embodiment of the present invention.

Specifically, if the user on the third terminal side selects the option “subscribe to the video data published by the first terminal” through an operation such as mouse click, after detecting that the option “subscribe to the video data published by the first terminal” is selected, the third terminal returns, to the server, a request of subscribing to the video data published by the first terminal; if the user on the third terminal side selects the option “subscribe to the video data published by the second terminal” through an operation such as mouse click, after detecting that the option “subscribe to the video data published by the second terminal” is selected, the third terminal returns, to the server, a request of subscribing to the video data published by the second terminal; and if not detecting that a subscription option is selected, the third terminal does not need to return a subscription request to the server, and can directly ignore the subscription notification.

It is taken as an example for illustration in the embodiment of the present invention that the third terminal transmits, to the server, a subscription request of subscribing to the video data published by the first terminal and the video data published by the second terminal.

510: The server receives the subscription request returned by the third terminal, and transmits, according to the subscription request, the video data published by the first terminal and the video data published by the second terminal to the third terminal.

Since the third terminal returns the subscription request to the server, the server may transmit, according to the subscription request, the video data published by the first terminal and the video data published by the second terminal to the third terminal. Besides, the method provided by this embodiment further provides a function that the third terminal subscribes to the video data published by the first terminal or the second terminal. In the specific implementation, if the third terminal subscribes to the video data published by the first terminal, the server transmits the video data published by the first terminal to the third terminal according to the subscription request returned by the third terminal; and if the third terminal subscribes to the video data published by the second terminal, the server transmits the video data published by the second terminal to the third terminal according to the subscription request returned by the third terminal.

511: After receiving the video data published by the first terminal and the video data published by the second terminal that are transmitted by the server, the third terminal displays the video data published by the first terminal and the video data published by the second terminal on the same window interface.

The third terminal displays the received video data after receiving the video data returned by the server. Specifically, if the third terminal subscribes to the video data published by the first terminal and the video data published by the second terminal, the video data published by the first terminal and the video data published by the second terminal are displayed on the same window interface in the third terminal; if the third terminal subscribes to the video data published by the first terminal, the video data published by the first terminal is displayed on the window interface in the third terminal; and if the third terminal subscribes to the video data published by the second terminal, the video data published by the second terminal is displayed on the window interface in the third terminal. It is taken as an example for illustration in the embodiment of the present invention that the third terminal subscribes to both the video data published by the first terminal and the video data published by the second terminal.

The switching from the single-user video mode to the multi-user video mode is realized through the above steps, and in this process, the method provided by this embodiment further supports the switching from the multi-user video mode to the single-user video mode, which is specifically described in the following steps.

512: The first terminal transmits a microphone-connection cancel notification to the server.

In the multi-user video mode, to enable the user on the first terminal side to decide freely whether to continue a microphone-connection session with the user on the second terminal side, the method provided by this embodiment further provides an option “cancel microphone-connection” in the multi-user video mode. After the user on the first terminal side selects the option “cancel microphone-connection” through an operation such as mouse click, the first terminal may transmit a microphone-connection cancel notification to the server according to the detected operation.

513: After receiving the microphone-connection cancel notification transmitted by the first terminal, the server disconnects the microphone-connection session connection between the first terminal and the second terminal according to the microphone-connection cancel notification.

After receiving the microphone-connection cancel notification transmitted by the first terminal, the server disconnects the microphone-connection session connection between the first terminal and the second terminal according to the microphone-connection cancel notification transmitted by the first terminal. The video interaction is thus switched from the multi-user video mode to the single-user video mode. That is, the displaying of the video data published by multiple terminals on the same window interface is switched to the displaying of the video data published by one terminal on the window interface.

514: The server transmits a microphone-connection stop notification to the second terminal, and transmits a subscription stop notification to the third terminal.

After the first terminal transmits the microphone-connection cancel notification to the server, the server disconnects the microphone-connection session connection between the first terminal and the second terminal according to the microphone-connection cancel notification transmitted by the first terminal, and transmits a microphone-connection stop notification to the second terminal, to enable the second terminal that establishes a microphone-connection session with the first terminal to learn about the microphone-connection cancel notification in time.

Further, Since the third terminal subscribes to the video data published by the first terminal and the video data published by the second terminal, after the first terminal cancels the microphone-connection session with the second terminal, the server cannot receive the video data published by the second terminal. Therefore, the server needs to transmit a subscription stop notification to the third terminal. The content of the subscription stop notification transmitted by the server to the third terminal includes, but is not limited to, “because the first terminal transmits a microphone-connection cancel notification, the publishing of the video data of the second terminal is stopped, and the subscription to the video data published by the second terminal fails”, which is not specifically limited in the embodiment of the present invention.

515: After receiving the microphone-connection stop notification transmitted by the server, the second terminal stops publishing a video according to the microphone-connection stop notification, and after receiving the subscription stop notification transmitted by the server, the third terminal stops displaying the video data published by the second terminal according to the subscription stop notification.

The second terminal is granted a video publishing right by the server after the second terminal receives the video microphone-connection invitation transmitted by the first terminal and has a microphone-connection session with the first terminal. Therefore, after disconnecting the microphone-connection session connection between the first terminal and the second terminal according to the microphone-connection cancel notification transmitted by the first terminal, the server revokes the video publishing right of the second terminal, and notifies the second terminal of the revocation. After receiving the microphone-connection stop notification, the second terminal stops publishing a video according to the microphone-connection stop notification. Meanwhile, as the server revokes the video publishing right of the second terminal, the third terminal cannot receive the video data published by the second terminal any more. Therefore, the third terminal stops displaying the video data published by the second terminal. As the third terminal user subscribes to both the video data published by the first terminal and the video data published by the second terminal, after the first terminal transmits the microphone-connection cancel notification to the server, the single-user video mode is recovered on the window interface of the first terminal, the window interface of the second terminal, and the window interface of the third terminal. That is, only a single-user video of an anchor is displayed on the window interfaces of the first terminal, the second terminal, and the third terminal.

Definitely, in addition to the above manner of switching the multi-user video mode to the single-user video mode, another manner may be adopted, in which the microphone-connection stop notification transmitted by the second terminal is received, and the microphone-connection session connection between the first terminal and the second terminal is disconnected according to the microphone-connection stop notification transmitted by the second terminal, such that the multi-user video mode is switched to the single-user video mode. Further, after receiving the microphone-connection stop notification transmitted by the second terminal, the server transmits the microphone-connection stop notification to the first terminal, and the first terminal recovers the single-user video mode after receiving the microphone-connection stop notification. Meanwhile, the server further transmits a subscription stop notification to the third terminal. After receiving the subscription stop notification transmitted by the server, the third terminal stops displaying the video data published by the second terminal according to the subscription stop notification. As the second terminal transmits the microphone-connection stop notification, the second terminal does not have a microphone-connection session with the first terminal, and therefore, the second terminal stops publishing a video.

In the method provided by this embodiment, by transmitting a video microphone-connection invitation, carrying at least one terminal identifier and transmitted by a first terminal, to a second terminal corresponding to the terminal identifier; after receiving an accept response returned by the second terminal, granting the second terminal a video publishing right, and establishing a microphone-connection session connection between the first terminal and the second terminal; displaying video data published by the first terminal and video data published by the second terminal on the same window interface in the first terminal, and displaying the video data published by the first terminal and the video data published by the second terminal on the same window interface in the second terminal, the video interaction mode is enriched. Besides, the single-user video mode and the multi-user video mode can be dynamically and flexibly switched, which increases the diversity of video interaction and achieves good user experience.

### Embodiment 3

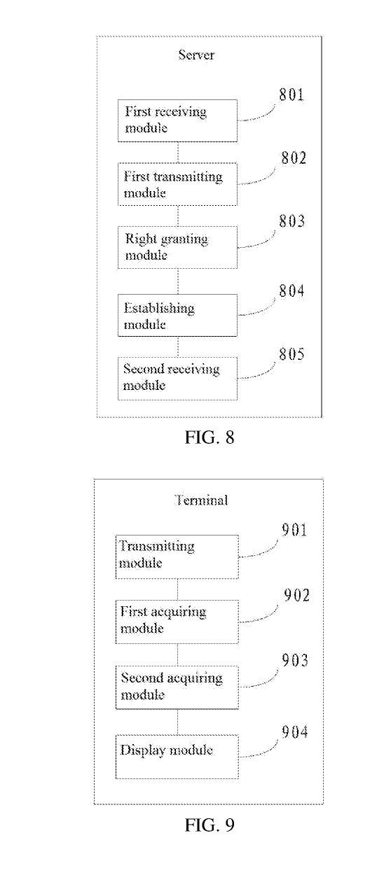

Referring to FIG. 8, an embodiment of the present invention provides a server, which is configured to perform the functions of the server in the video interaction method provided in Embodiment 1 or Embodiment 2. The server includes:

a first receiving module 801, configured to receive a video microphone-connection invitation transmitted by a first terminal, the video microphone-connection invitation carrying at least one terminal identifier;

a first transmitting module 802, configured to transmit the video microphone-connection invitation to a second terminal corresponding to the terminal identifier;

a right granting module 803, configured to grant the second terminal a video publishing right after receiving an accept response returned by the second terminal;

an establishing module 804, configured to establish a microphone-connection session connection between the first terminal and the second terminal; and

a second receiving module 805, configured to receive video data published by the first terminal and video data published by the second terminal, transmit the video data published by the first terminal to the second terminal, transmit the video data published by the second terminal to the first terminal, such that the first terminal displays the video data published by the first terminal and the video data published by the second terminal on the same window interface, and the second terminal displays the video data published by the first terminal and the video data published by the second terminal on the same window interface.

In a preferred embodiment, the server further includes:

a third receiving module, configured to receive a microphone-connection cancel notification transmitted by the first terminal;

a first disconnecting module, configured to disconnect the microphone-connection session connection between the first terminal and the second terminal according to the microphone-connection cancel notification; and

a second transmitting module, configured to transmit a microphone-connection stop notification to the second terminal, to stop the second terminal from publishing a video.

In a preferred embodiment, the server further includes:

a fourth receiving module, configured to receive a video publishing stop notification transmitted by the second terminal;

a second disconnecting module, configured to disconnect the microphone-connection session connection between the first terminal and the second terminal according to the video publishing stop notification; and

a third transmitting module, configured to transmit a microphone-connection stop notification to the first terminal, to stop the first terminal from displaying the video data published by the second terminal on the window interface.

In a preferred embodiment, the server further includes:

a fourth transmitting module, configured to transmit a subscription notification to at least one third terminal, the subscription notification being used for notifying subscription to the video data published by the first terminal and the video data published by the second terminal;

a fifth receiving module, configured to receive a subscription request returned by the third terminal; and

a fifth transmitting module, configured to transmit, according to the subscription request, the video data published by the first terminal and the video data published by the second terminal to the third terminal, such that the third terminal displays the video data published by the first terminal and the video data published by the second terminal on the same window interface.

In a preferred embodiment, the server further includes:

a sixth transmitting module, configured to transmit a subscription stop notification to the third terminal, to stop the third terminal from displaying the video data published by the second terminal.

In a preferred embodiment, the server further includes:

a right checking module, configured to check whether the second terminal has a video publishing right; and

the first transmitting module, configured to, transmit the video microphone-connection invitation to the second terminal when the second terminal has the video publishing right.

According to the server provided by the embodiment of the present invention, by transmitting a video microphone-connection invitation, carrying at least one terminal identifier and transmitted by a first terminal, to a second terminal corresponding to the terminal identifier; after receiving an accept response returned by the second terminal, granting the second terminal a video publishing right, and establishing a microphone-connection session connection between the first terminal and the second terminal; and video data published by the first terminal and video data published by the second terminal are displayed on the same window interface respectively in the first terminal and the second terminal, the video interaction mode is enriched.

### Embodiment 4

Referring to FIG. 9, an embodiment of the present invention provides a terminal, which is configured to perform the functions of the first terminal in the video interaction method provided in Embodiment 1 or Embodiment 2. The terminal includes:

a transmitting module 901, configured to transmit a video microphone-connection invitation to a server, the video microphone-connection invitation carrying at least one terminal identifier, such that the server transmits the video microphone-connection invitation to a second terminal corresponding to the terminal identifier, and establishes a microphone-connection session connection with the second terminal after receiving an accept response returned by the second terminal;

a first acquiring module 902, configured to acquire local video data;

a second acquiring module 903, configured to acquire video data published by the second terminal; and

a display module 904, configured to display the acquired local video data and the video data published by the second terminal on the same window interface.

According to the terminal provided by the embodiment of the present invention, by transmitting a video microphone-connection invitation carrying at least one terminal identifier to a server; acquiring local video data after establishing a microphone-connection session with a second terminal; uploading the acquired local video data to the server; and after acquiring video data published by the second terminal, displaying the acquired local video data and the video data published by the second terminal on the same window interface, the video interaction is enriched because the local video data and the video data published by the second terminal can be displayed on the same window interface.

### Embodiment 5

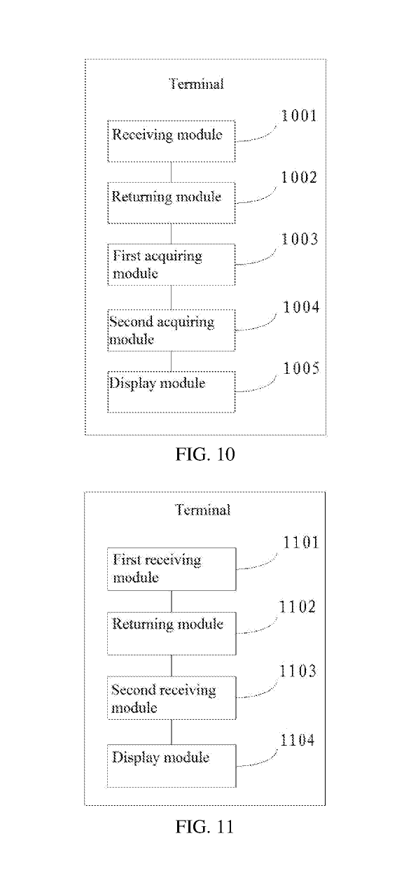

Referring to FIG. 10, an embodiment of the present invention provides a terminal, which is configured to perform the functions of the second terminal in the video interaction method provided in Embodiment 1 or Embodiment 2. The terminal includes:

a receiving module 1001, configured to receive a video microphone-connection invitation transmitted by a server, the video microphone-connection invitation being transmitted by a first terminal to the server;

a returning module 1002, configured to return an accept response to the server;

a first acquiring module 1003, configured to acquire local video data after being granted a video publishing right;

a second acquiring module 1004, configured to acquire video data published by the first terminal; and

a display module 1005, configured to display the acquired local video data and the video data published by the first terminal on the same window interface.

According to the terminal provided by the embodiment of the present invention, by receiving a video microphone-connection invitation transmitted by a first terminal to a server; returning an accept response to the server; acquiring local video data after being granted a video publishing right; uploading the acquired local video data to the server; and after acquiring video data published by the first terminal, displaying the acquired local video data and the video data published by the first terminal on the same window interface, the video interaction is enriched because the local video data and the video data published by the first terminal can be displayed on the same window interface.

### Embodiment 6

Referring to FIG. 11, an embodiment of the present invention provides a terminal, which is configured to perform the functions of the first terminal in the video interaction method provided in Embodiment 1 or Embodiment 2. The terminal includes:

a first receiving module 1101, configured to receive a subscription notification transmitted by a server, the subscription notification being used for notifying subscription to video data published by a first terminal and video data published by a second terminal;

a returning module 1102, configured to return a subscription request to the server;

a second receiving module 1103, configured to receive the video data transmitted by the server according to the subscription request, the video data being the video data published by the first terminal and the video data published by the second terminal; and

a display module 1104, configured to display the video data published by the first terminal and the video data published by the second terminal on the same window interface.

In a preferred embodiment, the terminal further includes:

a third receiving module, configured to receive a subscription stop notification transmitted by the server; and

a stopping module, configured to stop displaying the video data published by the second terminal according to the subscription stop notification.

According to the terminal provided by the embodiment of the present invention, by receiving a notification, transmitted by a server, of subscribing to video data published by a first terminal and video data published by a second terminal; returning a subscription request to the server; and displaying, on the same window interface, the video data published by the first terminal and the video data published by the second terminal that are transmitted by the server, the video interaction is enriched.

### Embodiment 7

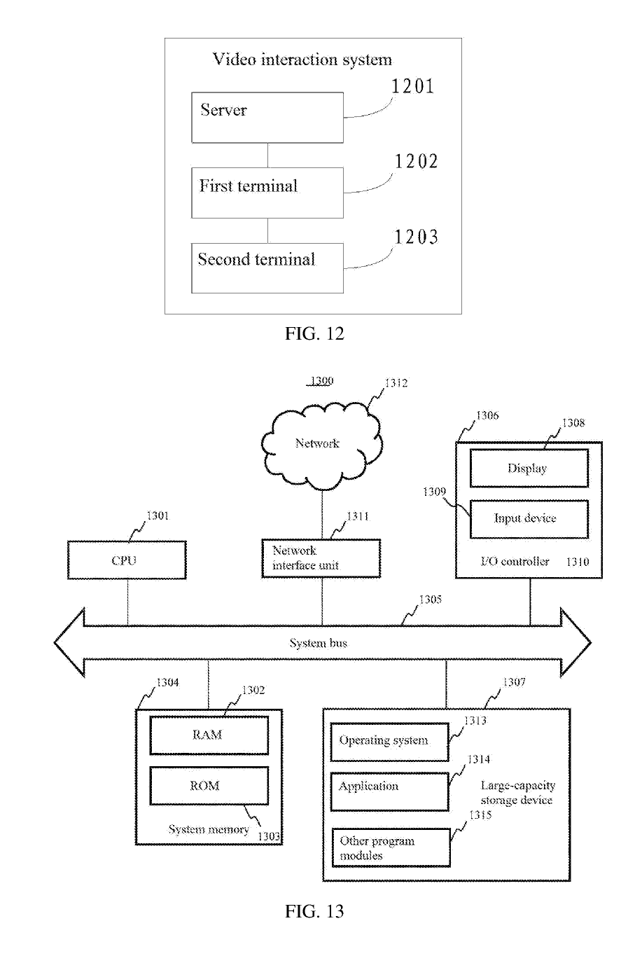

Referring to FIG. 12, an embodiment of the present invention provides a video interaction system, which includes: a server 1201, a first terminal 1202, and a second terminal 1203;

the server being as the server provided in Embodiment 3, where the specific description may refer to the content in Embodiment 3, and the details may not be repeated herein;

the first terminal being as the first terminal provided in Embodiment 4, where the specific description may refer to the content in Embodiment 4, and the details may not be repeated herein;

the second terminal being as the second terminal provided in Embodiment 5, where the specific description may refer to the content in Embodiment 5, and the details may not be repeated herein.

In a preferred embodiment, the system further includes a third terminal, the third terminal being as the third terminal provided in Embodiment 6, where the specific description may refer to the content in Embodiment 6, and the details may not be repeated herein.

According to the system provided by this embodiment, by transmitting a video microphone-connection invitation, carrying at least one terminal identifier and transmitted by a first terminal, to a second terminal corresponding to the terminal identifier; after receiving an accept response returned by the second terminal, granting the second terminal a video publishing right, and establishing a microphone-connection session connection between the first terminal and the second terminal; and displaying video data published by the first terminal and video data published by the second terminal on the same window interface respectively in the first terminal and the second terminal, the video interaction mode is enriched.

It should be noted that, during video interaction of the terminal and the server provided by the above embodiments, the division of the functional modules is merely taken as an example for illustration, and in the actual application, the above functions may be allocated to different functional modules for accomplishment according to requirements, that is, the internal structures of the terminal and the server are divided into different functional modules to accomplish all or a part of the functions described above. Further, the terminal, the server, and the video interaction system provided by the above embodiments have the same concept as the embodiments of the video interaction method, such that the specific implementing process may refer to the method embodiments, and the details may not be repeated herein.

### Embodiment 8

FIG. 13 shows an illustrative terminal system structure of a terminal 1300 used in an embodiment of the present invention. The terminal 1300 may be a mobile phone, tablet computer, laptop portable computer, desktop computer, or smart TV. The terminal 1300 includes a CPU 1301, a system memory 1304 including a random access memory (RAM) 1302 and a read-only memory (ROM) 1303, and a system bus 1305 for connecting the system memory 1304 and the CPU 1301. The terminal 1300 further includes a basic input/output (I/O) system 1306 that assists information transmission between devices in the terminal, and a large-capacity storage device 1307 configured to store operating systems, applications, and other program modules.

The basic I/O system 1306 includes a display 1308 configured to display information and an input device 1309 configured to input information by a user, such as a mouse or keyboard. The display 1308 and the input device 1309 are both connected to the CPU 1301 through an I/O controller 1310 connected to the system bus 1305. The basic I/O system 1306 may further include the I/O controller 1310 configured to receive and process input from other devices such as a keyboard, a mouse, or an electronic touch pen. Likewise, the I/O controller 1310 further provides an output device for output to a display screen, a printer, or the like.

The large-capacity storage device 1307 is connected to the CPU 1301 through a large-capacity storage controller (not shown) connected to the system bus 1305. The large-capacity storage device 1307 and a terminal readable medium related thereto provide non-volatile storage to the terminal 1300. That is, the large-capacity storage device 1307 may include a terminal readable medium (not shown) such as a hard disk or CD-ROM drive.

Without loss of generality, the computer readable medium may include a computer storage medium and a communication medium. The computer storage medium includes volatile and non-volatile, removable and non-removable media that are implemented by any method or technology and are configured to store information such as computer readable instructions, data structures, program modules, or other data. The computer storage medium includes RAM, ROM, EPROM, EEPROM, flash memory or other solid state storage technologies, CD-ROM, DVD or other optical storages, cassette tape, tape, disk storage or other magnetic storage devices. Definitely, persons skilled in the art can understand that the computer storage medium is not limited to the above types.

According to the embodiments of the present invention, the terminal 1300 may also be connected, over a network such as the Internet, to a remote computer on the network for running That is, the terminal 1300 may be connected to a network 1312 through a network interface unit 1311 connected to the system bus 1305, or may also be connected to a network of other types or a remote computer system (not shown) through the network interface unit 1311.

### Embodiment 9

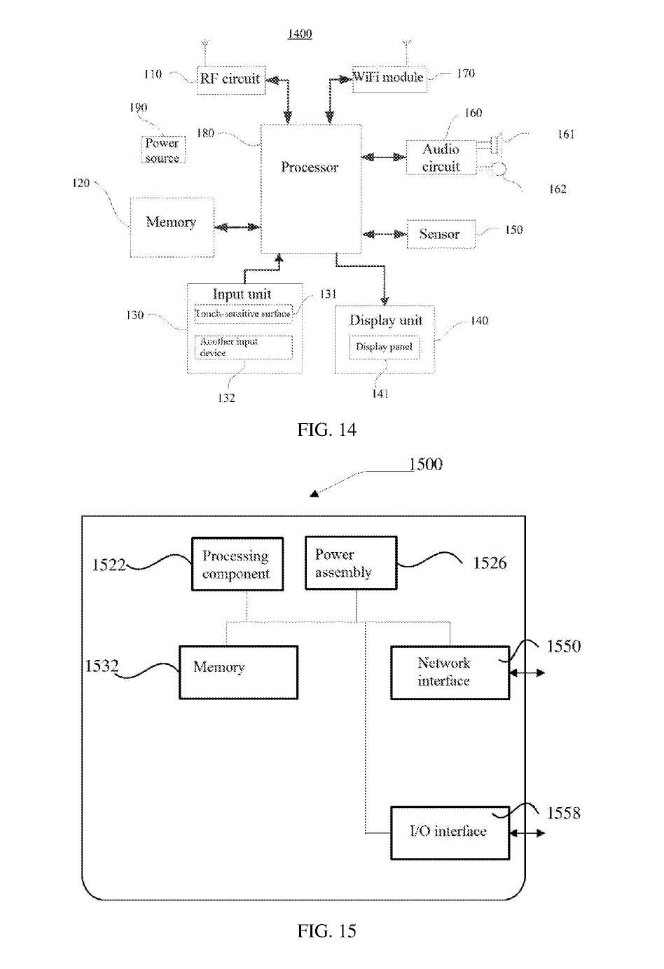

FIG. 14 is a schematic structural diagram of a terminal mentioned in an embodiment of the present invention. The terminal may be configured to perform the video interaction method provided in the above embodiments. The specific description is as follows.

The terminal 1400 may include a radio frequency (RF) circuit 110, a memory 120 including one or more computer readable storage media, an input unit 130, a display unit 140, a sensor 150, an audio circuit 160, a wireless fidelity (WiFi) module 170, a processor 180 including one or more processing cores, a power source 190, and other parts. Persons skilled in the art may understand that, the structure of the electronic device shown in FIG. 14 does not form a limit, and may include more or fewer parts than what are shown in the figure, or include combinations of some parts, or have different arrangement of the parts.

The RF circuit 110 may be configured to receive and transmit signals in an information receiving/transmitting process or a call process, and specifically, receive and submit downlink information from a base station to one or more processors 180 for processing; and transmit related uplink data to the base station. Generally, the RF circuit 110 includes, but is not limited to, an antenna, at least one amplifier, a tuner, one or more oscillators, a subscriber identity module (SIM) card, a transceiver, a coupler, a low noise amplifier (LNA), and a duplexer. Besides, the RF circuit 110 may communicate with a network and other devices through wireless communication. The wireless communication may use any communication standard or protocol, which includes, but is not limited to, Global System for Mobile Communications (GSM), general packet radio service (GPRS), code division multiple access (CDMA), wideband code division multiple access (WCDMA), long term evolution (LTE), e-mail, and short messaging service (SMS).

The memory 120 may be configured to store software programs and modules, and the processor 180 runs the software programs and modules stored in the memory 120 to perform various function applications and data processing. The memory 120 may mainly include a program storage area and a data storage area, where the program storage area may store an operating system, an application required by at least one function (for example, sound playing function or image playing function) and the like; the data storage area may store data created according to use of the terminal 1400 (for example, audio data or phonebook) and the like. Besides, the memory 120 may include a high-speed RAM, and may also include a non-volatile memory, for example, at least one disk storage or flash memory, or other volatile solid state storages. Correspondingly, the memory 120 may also include a memory controller that provides the processor 180 and the input unit 130 with access to the memory 120.

The input unit 130 may be configured to receive input digit or character information, and generate keyboard, mouse, joystick, optical or trackball signal input related to user setting and functional control. Specifically, the input unit 130 may include a touch-sensitive surface 131 and another input device 132. The touch-sensitive surface 131 may also be referred to as a touch display screen or touch panel, capable of collecting touch operations of a user thereon or nearby (for example, operations made by a user on the touch-sensitive surface 131 or near the touch-sensitive surface 131 using any suitable objects or accessories such as a finger or touch pen), and driving corresponding connection devices according to a preset program. Optionally, the touch-sensitive surface 131 may include a touch detection device and a touch controller. The touch detection device detects the touch position of a user and detects a signal produced by the touch operation, and transmits the signal to the touch controller. The touch controller receives touch information from the touch detection device, converts the touch information into contact coordinates, and transmits the contact coordinates to the processor 180; and the touch controller may receive and execute a command sent by the processor 180. Besides, the touch-sensitive surface 131 may be of resistive, capacitive, infrared, and surface acoustic wave types. In addition to the touch-sensitive surface 131, the input unit 130 may also include other input device 132. Specifically, other input device 132 may include, but is not limited to, one or more of a physical keyboard, functional button (for example, volume control button or on-off button), trackball, mouse, and joystick.

The display unit 140 may be configured to display information input by a user or information provided to a user and various graphical user interfaces of the terminal 1400, where these graphical user interfaces may be constituted by graphics, texts, icons, videos, and any combination thereof. The display unit 140 may include a display panel 141, and optionally, the display panel 141 may be configured in the form of a liquid crystal display (LCD), an organic light-emitting diode (OLED) or the like. Further, the touch-sensitive surface 131 may cover the display panel 141, and when detecting a touch operation thereon or nearby, the touch-sensitive surface 131 transmits the touch operation to the processor 180 to determine the type of a touch event, and then the processor 180 provides corresponding visual output on the display panel 141 according to the type of the touch event. Although the touch-sensitive surface 131 and the display panel 141 function as two independent parts for achieving input and input functions in FIG. 14, the touch-sensitive surface 131 and the display panel 141 may be integrated to achieve the input and output functions in some embodiments.

The terminal 1400 may further include at least a sensor 150, for example, an optical sensor, a motion sensor, or other sensors. Specifically, the optical sensor may include an ambient light sensor and a proximity sensor, where the ambient light sensor may adjust the brightness of the display panel 141 according to the ambient light, and the proximity sensor may turn off the display panel 141 and/or backlight when the terminal 1400 approaches the ear. As one type of the motion sensor, a gravity acceleration sensor, capable of detecting the acceleration in each direction (the sensor generally being tri-axis) and detecting the magnitude and direction of gravity in a static state, may be used in applications for identifying mobile phone postures (for example, landscape mode and portrait mode switching, related games, and magnetometer posture calibration), vibration identification related functions (for example, pedometer and tapping), and the like. The terminal 1400 may also be configured with other sensors such as gyroscope, barometer, hygrometer, thermometer, and infrared sensor, which are not described in detail herein.

The audio circuit 160, a speaker 161, and a microphone 162 may provide an audio interface between a user and the terminal 1400. The audio circuit 160 may transmit an electrical signal obtained by converting received audio data to the speaker 161, and the speaker 161 converts the electrical signal into a sound signal for output. On the other side, the microphone 162 converts a collected sound signal into an electrical signal; the audio circuit 160 receives the electrical signal, then converts the electrical signal into audio data, and outputs the audio data to the processor 180 for processing; and the processed audio data is transmitted to another electronic device through the RF circuit 110, or the audio data is output to the memory 120 for further processing. The audio circuit 160 may also include an earbud jack, to provide communication between an external headset and the terminal 1400.

WiFi belongs to the short-distance wireless transmission technology. The terminal 1400 may assist a user to receive and transmit e-mails, browse web pages and access streaming media through the WiFi module 170, and provides wireless access to the broadband Internet to the user. Although the WiFi module 170 is shown in FIG. 14, it may be understood that, the WiFi module 170 is optional in the construction of the terminal 1400 and can definitely be omitted according to requirements without changing the essence of the present invention.

The processor 180, being a control center of the terminal 1400, uses various types of interfaces and circuits to connect to every part of a mobile phone, and executes various functions of the terminal 1400 and processes data by means of running or executing the software programs and/or modules stored in the memory 120 and invoking data stored in the memory 120, thereby monitoring the entire mobile phone. Optionally, the processor 180 may include one or more processing cores. Preferably, the processor 180 may be integrated with an application processor and a modem processor, where the application processor mainly processes an operating system, a user interface, and an application, and the modem processor mainly processes wireless communication. It may be understood that, the modem processor may also not be integrated into the processor 180.

The terminal 1400 also includes the power source 190 (for example, a battery) for supplying power to each part. Preferably, the power source may be logically connected to the processor 180 through a power management system, to realize functions such as charging, discharging, and power consumption management through the power management system. The power source 190 may further include one or more direct-current or alternating-current power sources, recharging systems, power failure detecting circuits, power convertors or inverters, power status indicators, or any other components.

Although not shown, the terminal 1400 may also include a camera and a Bluetooth module, which is not described in detail herein. Specifically in this embodiment, the display unit of the electronic device is a touch screen display, and the electronic device further includes a memory and one or more programs, where the one or more programs are stored in the memory, and are configured to be executed by one or more processors, and the one or more programs contain instructions for performing the operations in Embodiment 1, Embodiment 2, and Embodiment 3.

### Embodiment 10

FIG. 15 is a schematic structural diagram of a server according to an embodiment of the present invention. Referring to FIG. 15, the server 1500 includes a processing component 1522 which further includes one or more processors, and memory resources which are represented by a memory 1532 and are configured to store instructions, for example, applications, capable of being executed by the processing component 1522. The applications stored in the memory 1532 may include one or more modules, each corresponding to a set of instructions. Besides, the processing component 1522 is configured to execute instructions, so as to execute the instructions executed by the server in the corresponding method embodiments in FIG. 1 to FIG. 5.

The server 1500 may further include a power assembly 1526 configured to execute power management of the server 1500, a wired or wireless network interface 1550 configured to connect the server 1500 to a network, and an I/O interface 1558. The server 1500 may run an operating system stored in the memory 1532, for example, Windows Server™, Mac OS X™, Unix™, Linux™, FreeBSD™ or the like.

In another aspect, another embodiment of the present invention further provides a computer readable storage medium. The computer readable storage medium may be a computer readable storage medium contained in the memory in the above embodiment; and may also be an independent computer readable storage medium that is not assembled in a server. The computer readable storage medium stores one or more programs, and the one or more programs are used by one or more processors to perform a video interaction method, which includes:

receiving a video microphone-connection invitation transmitted by a first terminal, the video microphone-connection invitation carrying at least one terminal identifier;

transmitting the video microphone-connection invitation to a second terminal corresponding to the terminal identifier;

after receiving an accept response returned by the second terminal, granting the second terminal a video publishing right, and establishing a microphone-connection session connection between the first terminal and the second terminal;

receiving video data published by the first terminal and video data published by the second terminal; and

transmitting the video data published by the first terminal to the second terminal, transmitting the video data published by the second terminal to the first terminal, such that the first terminal displays the video data published by the first terminal and the video data published by the second terminal on the same window interface, and the second terminal displays the video data published by the first terminal and the video data published by the second terminal on the same window interface.

Preferably, after establishing a microphone-connection session connection between the first terminal and the second terminal, the method further includes:

receiving a microphone-connection cancel notification transmitted by the first terminal; and

disconnecting the microphone-connection session connection between the first terminal and the second terminal according to the microphone-connection cancel notification, and transmitting a microphone-connection stop notification to the second terminal, to stop the second terminal from publishing a video.

Preferably, after establishing a microphone-connection session connection between the first terminal and the second terminal, the method further includes:

receiving a video publishing stop notification transmitted by the second terminal; and

disconnecting the microphone-connection session connection between the first terminal and the second terminal according to the video publishing stop notification, and transmitting a microphone-connection stop notification to the first terminal, to stop the first terminal from displaying the video data published by the second terminal on the window interface.

Preferably, after receiving video data published by the first terminal and video data published by the second terminal, the method further includes:

transmitting a subscription notification to at least one third terminal, and receiving a subscription request returned by the third terminal, the subscription notification being used for notifying subscription to the video data published by the first terminal and the video data published by the second terminal; and

transmitting, according to the subscription request, the video data published by the first terminal and the video data published by the second terminal to the third terminal, and such that the third terminal displays the video data published by the first terminal and the video data published by the second terminal on the same window interface.

Preferably, after disconnecting the microphone-connection session connection between the first terminal and the second terminal, the method further includes:

transmitting a subscription stop notification to the third terminal, to stop the third terminal from displaying the video data published by the second terminal.

Preferably, before transmitting the video microphone-connection invitation to a second terminal corresponding to the terminal identifier, the method further includes:

checking whether the second terminal has a video publishing right; and

transmitting the video microphone-connection invitation to the second terminal when the second terminal has the video publishing right.

According to the computer readable storage medium provided by the embodiment of the present invention, by transmitting a video microphone-connection invitation, carrying at least one terminal identifier and transmitted by a first terminal, to a second terminal corresponding to the terminal identifier; after receiving an accept response returned by the second terminal, granting the second terminal a video publishing right, and establishing a microphone-connection session connection between the first terminal and the second terminal; displaying video data published by the first terminal and video data published by the second terminal on the same window interface in the first terminal, and displaying the video data published by the first terminal and the video data published by the second terminal on the same window interface in the second terminal, the video interaction mode is enriched.

The sequence numbers of the above embodiments of the present invention are merely for the convenience of description, and do not imply the preference among the embodiments.

Persons of ordinary skill in the art can understand that all or a part of the steps for implementing the above embodiments may be performed by hardware or by a program instructing relevant hardware. The program may be stored in a computer readable storage medium. The storage medium may be a read-only memory, a magnetic disk, or an optical disc.

The above descriptions are merely preferred embodiments of the present invention, but not intended to limit the present invention. Any modification, equivalent replacement, and improvement made without departing from the spirit and principle of the present invention shall fall within the protection scope of the present invention.

1. A video interaction method, comprising:
receiving a video microphone-connection invitation transmitted by a first terminal, the video microphone-connection invitation carrying at least one terminal identifier;
transmitting the video microphone-connection invitation to a second terminal corresponding to the terminal identifier;
after receiving an accept response returned by the second terminal, granting the second terminal a video publishing right, and establishing a microphone-connection session connection between the first terminal and the second terminal;
receiving video data published by the first terminal and video data published by the second terminal; and
transmitting the video data published by the first terminal to the second terminal, transmitting the video data published by the second terminal to the first terminal, wherein the first terminal displays the video data published by the first terminal and the video data published by the second terminal on the same window interface, and the second terminal displays the video data published by the first terminal and the video data published by the second terminal on the same window interface.

2. The method according to claim 1, wherein after establishing a microphone-connection session connection between the first terminal and the second terminal, the method further comprises:
receiving a microphone-connection cancel notification transmitted by the first terminal; and
disconnecting the microphone-connection session connection between the first terminal and the second terminal according to the microphone-connection cancel notification, and transmitting a microphone-connection stop notification to the second terminal, to stop the second terminal from publishing a video.

3. The method according to claim 1, wherein after establishing a microphone-connection session connection between the first terminal and the second terminal, the method further comprises:
receiving a video publishing stop notification transmitted by the second terminal; and
disconnecting the microphone-connection session connection between the first terminal and the second terminal according to the video publishing stop notification, and transmitting a microphone-connection stop notification to the first terminal, to stop the first terminal from displaying the video data published by the second terminal on the window interface.

4. The method according to claim 1, wherein after receiving video data published by the first terminal and video data published by the second terminal, the method further comprises:
transmitting a subscription notification to at least one third terminal, and receiving a subscription request returned by the third terminal, the subscription notification being used for notifying subscription to the video data published by the first terminal and the video data published by the second terminal; and
transmitting, according to the subscription request, the video data published by the first terminal and the video data published by the second terminal to the third terminal, such that the third terminal displays the video data published by the first terminal and the video data published by the second terminal on the same window interface.

5. The method according to claim 4, wherein after disconnecting the microphone-connection session connection between the first terminal and the second terminal, the method further comprises:
transmitting a subscription stop notification to the third terminal, to stop the third terminal from displaying the video data published by the second terminal.

6. The method according to claim 1, wherein before transmitting the video microphone-connection invitation to a second terminal corresponding to the terminal identifier, the method further comprises:
checking whether the second terminal has a video publishing right; and
transmitting the video microphone-connection invitation to the second terminal when the second terminal has the video publishing right.

7. A video interaction method, comprising:
transmitting a video microphone-connection invitation to a server, the video microphone-connection invitation carrying at least one terminal identifier, such that the server transmits the video microphone-connection invitation to a second terminal corresponding to the terminal identifier, and establishes a microphone-connection session connection with the second terminal after receiving an accept response returned by the second terminal;
acquiring local video data, and uploading the acquired local video data to the server; and
acquiring video data published by the second terminal, and displaying the acquired local video data and the video data published by the second terminal on the same window interface.

8. A video interaction method, comprising:
receiving a video microphone-connection invitation transmitted by a server, the video microphone-connection invitation being transmitted by a first terminal to the server;
returning an accept response to the server, and acquiring local video data after being granted a video publishing right; and
uploading the acquired local video data to the server, acquiring video data published by the first terminal, and displaying the acquired local video data and the video data published by the first terminal on the same window interface.

9. A video interaction method, comprising:
receiving a subscription notification transmitted by a server, and returning a subscription request to the server, the subscription notification being used for notifying subscription to video data published by a first terminal and video data published by a second terminal; and
receiving the video data transmitted by the server according to the subscription request, the video data being the video data published by the first terminal and the video data published by the second terminal, and displaying the video data published by the first terminal and the video data published by the second terminal on the same window interface.

10. The method according to claim 9, wherein after returning a subscription request to the server, the method further comprises:
receiving a subscription stop notification transmitted by the server, and stopping displaying the video data published by the second terminal according to the subscription stop notification.

11-22. (canceled)

23. A server, comprising: a central processing unit (CPU), a network interface unit, and a system memory, wherein the system memory stores a set of program code, and the CPU is configured to invoke, through a system bus, the program code stored in the system memory, to perform the following operations:
receiving a video microphone-connection invitation transmitted by a first terminal, the video microphone-connection invitation carrying at least one terminal identifier; transmitting the video microphone-connection invitation to a second terminal corresponding to the terminal identifier; after receiving an accept response returned by the second terminal, granting the second terminal a video publishing right, and establishing a microphone-connection session connection between the first terminal and the second terminal; receiving video data published by the first terminal and video data published by the second terminal; and transmitting the video data published by the first terminal to the second terminal, transmitting the video data published by the second terminal to the first terminal, wherein the first terminal displays the video data published by the first terminal and the video data published by the second terminal on the same window interface, and the second terminal displays the video data published by the first terminal and the video data published by the second terminal on the same window interface.

24. The server according to claim 23, wherein the CPU is configured to invoke the program code stored in the system memory, to perform the following operations:
receiving a microphone-connection cancel notification transmitted by the first terminal; and disconnecting the microphone-connection session connection between the first terminal and the second terminal according to the microphone-connection cancel notification, and transmitting a microphone-connection stop notification to the second terminal, to stop the second terminal from publishing a video.

25. The server according to claim 23, wherein the CPU is configured to invoke the program code stored in the system memory, to perform the following operations:
receiving a video publishing stop notification transmitted by the second terminal; and disconnecting the microphone-connection session connection between the first terminal and the second terminal according to the video publishing stop notification, and transmitting a microphone-connection stop notification to the first terminal, to stop the first terminal from displaying the video data published by the second terminal on the window interface.

26. The server according to claim 23, wherein the CPU is configured to invoke the program code stored in the system memory, to perform the following operations:
transmitting a subscription notification to at least one third terminal, and receiving a subscription request returned by the third terminal, the subscription notification being used for notifying subscription to the video data published by the first terminal and the video data published by the second terminal; and transmitting, according to the subscription request, the video data published by the first terminal and the video data published by the second terminal to the third terminal, such that the third terminal displays the video data published by the first terminal and the video data published by the second terminal on the same window interface.

27. The server according to claim 26, wherein the CPU is configured to invoke the program code stored in the system memory, to perform the following operation:
transmitting a subscription stop notification to the third terminal, to stop the third terminal from displaying the video data published by the second terminal.

28. The server according to claim 23, wherein the CPU is configured to invoke the program code stored in the system memory, to perform the following operations:
checking whether the second terminal has a video publishing right; and transmitting the video microphone-connection invitation to the second terminal when the second terminal has the video publishing right.

29. A terminal, comprising: a central processing unit (CPU), a network interface unit, a sensor, a microphone, a display, and a system memory, wherein the system memory stores a set of program code, and the CPU is configured to invoke, through a system bus, the program code stored in the system memory, to perform the following operations:
transmitting a video microphone-connection invitation to a server, the video microphone-connection invitation carrying at least one terminal identifier, such that the server transmits the video microphone-connection invitation to a second terminal corresponding to the terminal identifier, and establishes a microphone-connection session connection with the second terminal after receiving an accept response returned by the second terminal; acquiring local video data, and uploading the acquired local video data to the server; and acquiring video data published by the second terminal, and displaying the acquired local video data and the video data published by the second terminal on the same window interface.

30. A terminal, comprising: a central processing unit (CPU), a network interface unit, a sensor, a microphone, a display, and a system memory, wherein the system memory stores a set of program code, and the CPU is configured to invoke, through a system bus, the program code stored in the system memory, to perform the following operations:
receiving a video microphone-connection invitation transmitted by a server, the video microphone-connection invitation being transmitted by a first terminal to the server; returning an accept response to the server, and acquiring local video data after being granted a video publishing right; and uploading the acquired local video data to the server, acquiring video data published by the first terminal, and displaying the acquired local video data and the video data published by the first terminal on the same window interface.

31. A terminal, comprising: a, central processing unit (CPU), a network interface unit, a sensor, a microphone, a display, and a system memory, wherein the system memory stores a set of program code, and the CPU is configured to invoke, through a system bus, the program code stored in the system memory, to perform the following operations:
receiving a subscription notification transmitted by a server, and returning a subscription request to the server, the subscription notification being used for notifying subscription to video data published by a first terminal and video data published by a second terminal; receiving the video data transmitted by the server according to the subscription request, the video data being the video data published by the first terminal and the video data published by the second terminal, and displaying the video data published by the first terminal and the video data published by the second terminal on the same window interface.

32. The terminal according to claim 31, wherein the CPU is configured to invoke the program code stored in the system memory, to perform the following operations:
receiving a subscription stop notification transmitted by the server, and stopping displaying the video data published by the second terminal according to the subscription stop notification.
